(19) United States
(12) Patent Application Publication
(10) Pub. No.: US 2017/0057023 A1
(43) Pub. Date: Mar. 2, 2017

(54) Piston and Method of Piston Remanufacturing

(71) Applicant: Caterpillar Inc., Peoria, IL (US)

(72) Inventors: Robert E. Sharp, Peoria, IL (US); Bradley T. Bonds, Peoria, IL (US)

(73) Assignee: CATERPILLAR INC., Peoria, IL (US)

(21) Appl. No.: 14/836,277

(22) Filed: Aug. 26, 2015

(51) Int. Cl. B23P 6/02; F02F 3/10; F02F 3/00; F02F 3/26

(52) U.S. Cl. CPC B23P 6/02; F02F 3/26; F02F 3/10; F02F 3/0084

(57) ABSTRACT

A method of remanufacturing a piston includes machining an exterior surface of a body of the piston to define a reference surface. The reference surface is inwardly offset relative to a portion of the exterior surface adjacent the reference surface. The body is made from a body material comprising a metal. A layer of a cold spray powder is applied to the reference surface via cold spraying to define a piston blank surface. The piston blank surface is outwardly offset relative to the portion of the exterior surface adjacent the reference surface. The cold spray powder is made from a powder material comprising the metal. The piston blank surface is machined to define a piston finish surface. The piston finish surface has a dimension which is within a predetermined range.

### TECHNICAL FIELD

This patent disclosure relates generally to remanufacturing a worn or damaged component and, more particularly, to remanufacturing a piston for an internal combustion engine.

### BACKGROUND

Worn or broken machine components are regularly rebuilt, or “remanufactured,” and used again. Systems and components that otherwise would be scrapped can be repaired and/or refurbished and returned to service. However, often the dimensions and other properties of the remanufactured component are different from the original component, frequently as a result of the remanufacturing techniques used to rebuild the component. An increased bore size of a remanufactured cylinder of an internal combustion engine is such an example. It is desirable in many instances, however, for a component to be remanufactured such that its operability is restored and its final dimensions meet the original dimensional specifications of a new part.

One class of machinery parts where balancing these potentially competing goals of technical sufficiency and dimensional conformance has proven quite challenging are internal combustion engine components, such as pistons. In the case of pistons, it is commonplace for replacement pistons supplied for installation in a remanufactured engine to be new because many pistons removed from service are presumed to be too difficult, time-consuming, and/or uneconomical to be remanufactured.

U.S. Pat. No. 7,479,299 is entitled, “Methods of Forming High Strength Coatings,” and is directed to a method for coating turbine engine components. The method utilizes a cold high velocity gas spray technique to coat turbine blades, compressor blades, impellers, blisks, and other turbine engine components. The method includes the deposition of powders of alloys of nickel and aluminum wherein the powders are formed so as to have an amorphous microstructure. Layers of the alloys may be deposited and built up by cold high velocity gas spraying.

There is a continued need in the art to provide additional solutions to enhance the remanufacturing process for engine components, particularly pistons. For example, there is a continued need for remanufacturing techniques that produce remanufactured components which are readily produced so as to restore the remanufactured part to a satisfactory operating condition for a renewed useful life of the remanufactured part and to conform to the original dimensional specifications of a new part.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a method of remanufacturing a piston that includes machining an exterior surface of a body of the piston to define a reference surface. The reference surface is inwardly offset relative to a portion of the exterior surface adjacent the reference surface. The body is made from a body material comprising a metal. A layer of a cold spray powder is applied to the reference surface via cold spraying to define a piston blank surface. The piston blank surface is outwardly offset relative to the portion of the exterior surface adjacent the reference surface. The cold spray powder is made from a powder material comprising the metal. The piston blank surface is machined to define a piston finish surface. The piston finish surface has a dimension which is within a predetermined range.

In yet another embodiment, a piston includes a body and a body filler portion. The body includes an exterior surface and a reference surface which is inwardly offset relative to a portion of the exterior surface adjacent the reference surface. The body is made from a body material comprising a metal. The body filler portion is connected to the reference surface of the body and comprises a cold-spray deposited layer of a cold spray powder. The cold spray powder is made from a powder material comprising the metal. The body filler portion includes a machined piston finish surface having a dimension within a predetermined range.

Further and alternative aspects and features of the disclosed principles will be appreciated from the following detailed description and the accompanying drawings. As will be appreciated, the principles related to pistons and methods of remanufacturing pistons disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of an embodiment of a piston.

FIG. 2 is a longitudinal cross-sectional view of the piston of FIG. 1 taken along line II-II in FIG. 1.

FIG. 3 is a diagrammatic view of cold spray equipment suitable for use in an embodiment of a method of remanufacturing a piston following principles of the present disclosure.

FIG. 4 is a flowchart illustrating steps of an embodiment of a method of remanufacturing a piston following principles of the present disclosure.

FIGS. 5-7 are fragmentary, enlarged cross-sectional views of a piston undergoing sequential steps in the method of remanufacturing a piston of FIG. 4.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides embodiments of methods of remanufacturing a piston and pistons remanufactured by the same. In embodiments, a piston constructed in accordance with principles of the present disclosure can be incorporated into any suitable machine. In embodiments, the machine can include an engine which has one or more pistons constructed in accordance with principles of the present disclosure. Examples of such machines include mobile or fixed machines used for construction, farming, mining, forestry, transportation, and other similar industries. In some embodiments, the machine can be an excavator, tractor, wheel loader, backhoe, crane, compactor, dozer, wheel tractor-scraper, material-handling machine, or any other suitable machine which includes a piston.

Embodiments of a piston constructed according to principles of the present disclosure can have a body with a repair portion comprising a body filler portion which is produced using a cold spray process. In embodiments, the repair material is substantially the same as the body material. In embodiments, the repair portion is made from a material that is harder than the body material used to manufacture the body of the piston.

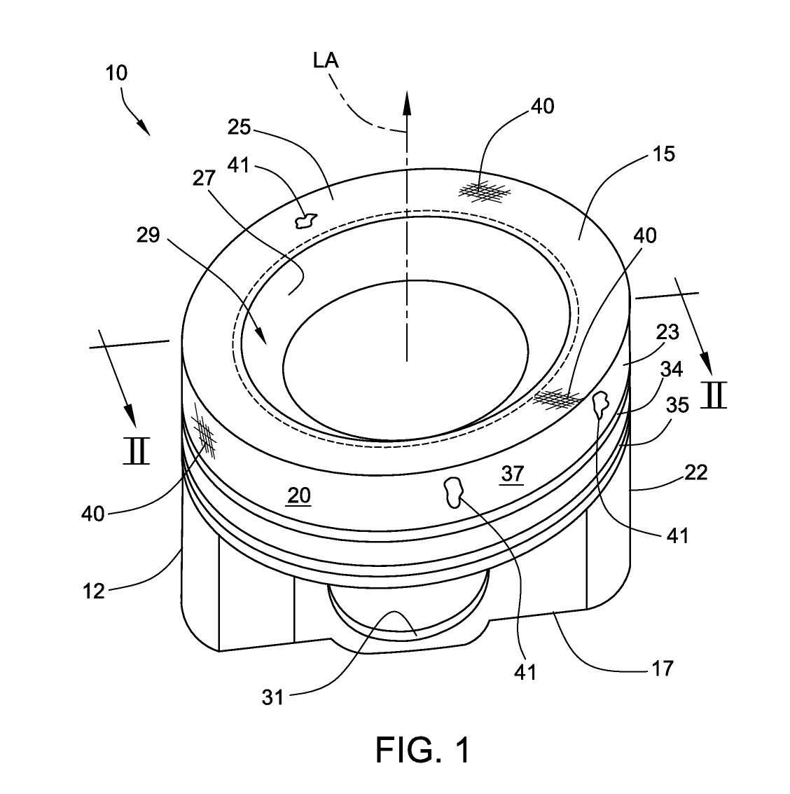

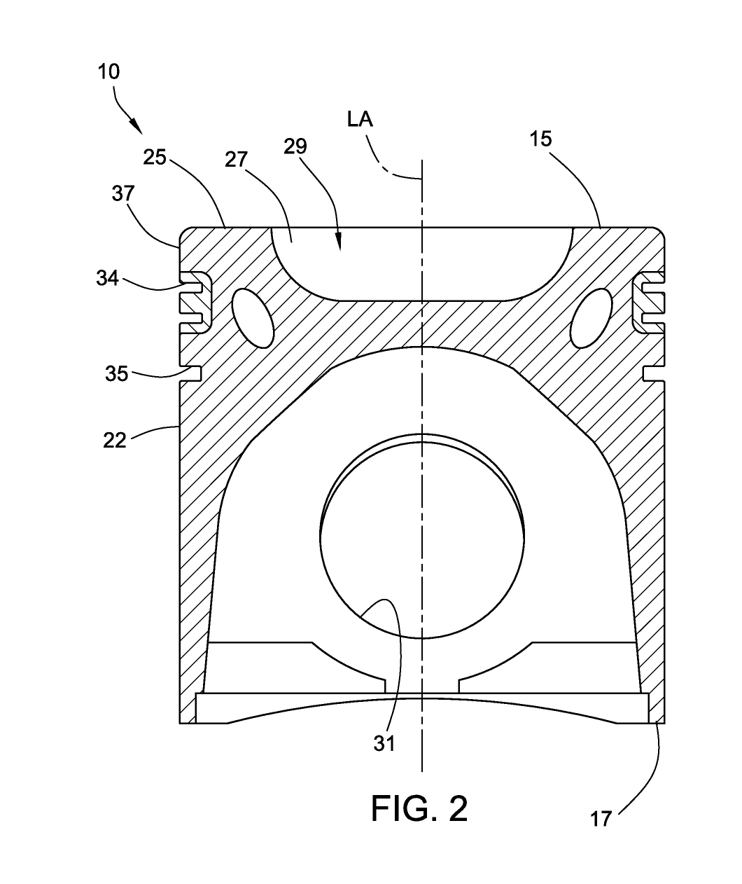

Turning now to the FIGURES, there is shown in FIGS. 1 and 2 an exemplary embodiment of a piston 10 having been removed from service in an internal combustion engine. The piston 10 includes a body 12 that defines a longitudinal axis LA. The piston body 12 includes a crown end 15 and a skirt end 17. The piston 10 can be made from any suitable material, such as, steel, cast iron, or aluminum, for example. In embodiments, the body material can be any suitable material that is typically used for a body of the particular type of component being made.

The body 12 includes an exterior surface 20 that includes a sidewall 22. The sidewall 22 circumscribes, and extends along, the longitudinal axis LA between the crown end 15 and the skirt end 17. The illustrated sidewall 22 includes a crown portion 23 that is generally cylindrical and extends axially along, and circumferentially around, the longitudinal axis LA.

The crown end 15 includes an annular rim 25 and a recessed portion 27. The annular rim 25 circumscribes the recessed portion 27 and cooperates with the recessed portion 27 to define a combustion bowl 29. The annular rim 25 extends circumferentially around the recessed portion 27 and extends in a radially outward direction from the recessed portion 27 to the sidewall 22. The illustrated recessed portion 27 has a concave shape in the form of a spherical segment as in a bowl.

The sidewall 22 defines a wrist pin bore 31 extending in a direction radially perpendicular to the longitudinal axis LA. The wrist pin bore 31 is configured to receive a wrist pin for coupling the piston body 12 and a piston rod together in a manner readily known to one skilled in the art.

A plurality of piston ring grooves 34, 35 are formed in the crown portion 23 of the sidewall 22 of the piston body 12 adjacent the crown end 15. The piston ring grooves 34, 35 circumscribe the sidewall 22 and extend circumferentially around longitudinal axis LA. A crown land 37 extends axially between an uppermost one of piston ring grooves 34 and the annular rim 25 of the crown end 15.

Referring to FIG. 1, the piston 10 includes a plurality of corroded areas 40 and a plurality of defects 41. In embodiments, the corroded areas 40 can comprise specification-violating defects, and in some embodiments can comprise: deposits of foreign material on the piston body 12, corroded body material of the piston body 12, body material which is corroded and pitted to a porous state, or still another feature as will be appreciated by one skilled in the art. In embodiments, the defects 41 can be in the form of abrasions, dents, pits, scratches, grooves, worn areas, and/or distended material, for example. In other instances, the defect 41 can comprise material of the piston body being chipped or flaked away to form a void. In embodiments, the corroded area 40 and/or the defect 41 can violate one or more specifications relating to the surface finish of a new piston. In embodiments, the corroded area 40 and/or the defect 41 can comprise a specification-violating feature in the exterior surface 20 within the crown land 37 or upon the crown end 15.

In embodiments, the piston 10 can be remanufactured according to principles of the present disclosure such that a remanufactured piston 50 includes a body filler portion 52 (see FIG. 7) which is placed in contacting relationship with the piston body 12 using cold spray depositing techniques. The body filler portion 52 can be made by a cold spray depositing process.

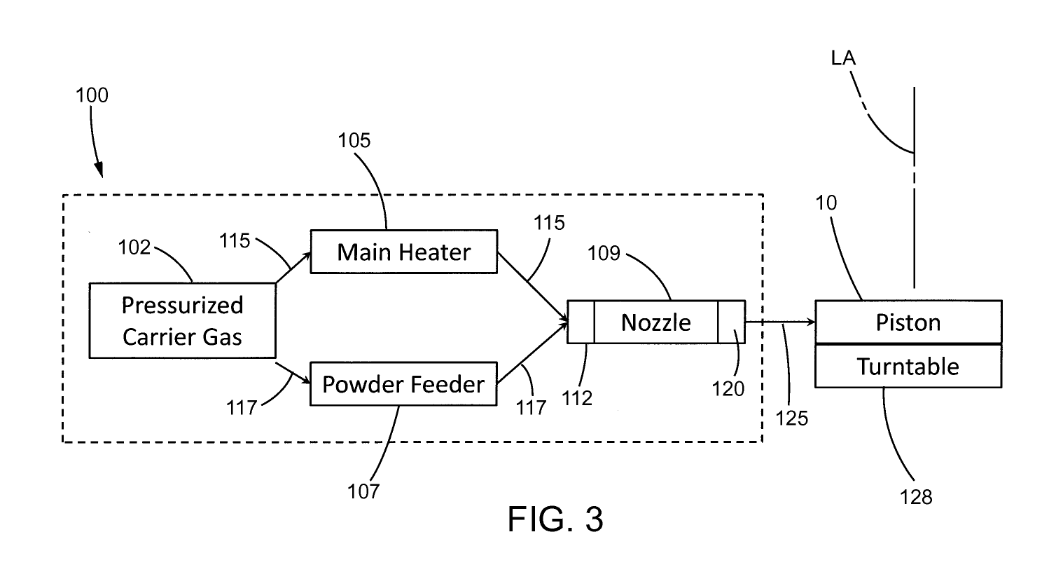

Referring to FIG. 3, there is shown an exemplary embodiment of a cold spray system 100 illustrated diagrammatically. The cold spray system 100 is configured to use powder particles to form a layer upon a surface of the piston 10, such as, in the form of the body filler portion 52 shown in FIG. 7, for example, by means of ballistic impingement upon the piston 10.

In embodiments, any suitable powder particles can be used with the cold spray system 100 to perform a method of remanufacturing a piston following principles of the present disclosure. For example, in embodiment, the powder particles can be made from a metal, such as aluminum, for example. Depending upon the type of wear to be resisted, the powder material can comprise a variety of different alloy compositions, as will be appreciated by one skilled in the art. For example, in embodiments, the powder material comprises an alloy, such as an aluminum alloy, for example. In yet other embodiments, the powder material comprises an alloy comprising one or more of iron, nickel, aluminum, zinc, copper, tungsten, and combinations thereof, for example. In embodiments, the powder material is an aluminum alloy comprising at least ninety percent aluminum by weight. In embodiments, the powder material is an aluminum alloy comprising aluminum and nickel, and comprising aluminum, nickel, and zinc in yet other embodiments. In embodiments, the mass median particle size of the powder can be between five and one hundred micrometers in diameter. In embodiments, one or more of the particle size distribution and particle attributes that influence the ability to form a compacted deposit (such as, oxide layer and mechanical properties, for example) can be varied.

The cold spray system 100 is referred to as a “cold spray” system because both the temperature of the powder-laden jet of carrier gas and the temperature of the powder itself are maintained below a threshold level to prevent a phase change in the powder. In embodiments, the powder particles are applied in the solid state, i.e., at a temperature which is lower than the melting point of the powder material. The kinetic energy of the powder particles on impact with the target surface, rather than particle temperature, causes the powder particles to plastically deform and bond with the target surface. Therefore, bonding the powder particles to the piston 10 takes place in a solid state with insufficient thermal energy to transition the solid powder particles to a molten state.

A variety of different systems and equipment can be used to perform a remanufacturing process using cold spraying according to principles of the present disclosure. In embodiments, the cold spray system 100 can include any suitable equipment configured to perform a material deposition process in which relatively small powder particles that are in the solid state are accelerated to a relatively high velocity and applied to a surface of a substrate (or piston) to produce a layer of the powder that is adhered thereto.

The illustrated cold spray system 100 includes a carrier gas supply 102, a main heater 105, a powder feeder 107, and a nozzle 109. The carrier gas supply 102 comprises a supply of pressurized carrier gas and is fluidly connected to a manifold system operably arranged with the main heater 105 and the powder feeder 107. The main heater 105 is fluidly connected to the pressurized carrier gas 102 and an inlet 112 of the nozzle 109 such that a first stream of pressurized carrier gas 115 is conveyed through the main heater 105 at a point upstream of the nozzle 109 and is delivered to the inlet 112 of the nozzle 109. The powder feeder 107 is fluidly connected to the pressurized carrier gas 102 and the nozzle 109 such that cold spray powder is conveyed from the powder feeder into the nozzle 109 by a second stream of pressurized carrier gas 117. The nozzle 109 comprises a gas manifold configured to accelerate the velocity of the carrier gas and the powder particles entrained therein as they moves from the inlet 112 to an outlet 120 of the nozzle 109.

The carrier gas supply 102 can comprise any suitable gas, such as a low molecular weight gas. In embodiments, the carrier gas comprises nitrogen, helium, a mixture of nitrogen and helium, or air, for example. In embodiments, a suitable gas compressor can be used to pressurize the carrier gas supply 102. In embodiments, the carrier gas supply 102 can be compressed to a pressure suitable for propelling the powder in a jet of carrier gas onto a surface of the piston sufficient to adhere the powder particles thereto. In embodiments, the carrier gas supply 102 is pressurized to any suitable pressure, such as in a range between 1.5 MPa and 4.5 MPa, for example, and in a range between 2 MPa and 2.5 MPa in some embodiments.

The main heater 105 can be configured to subject the first stream of pressurized carrier gas 115 to heat, such as at a preset temperature. In embodiments, the main heater 105 can include any suitable device for heating the first stream of pressurized carrier gas 115. For example, in embodiments, the main heater 105 can include a coil of an electrical resistance-heated tube. The main heater 105 can be configured to heat the first stream of pressurized carrier gas 115 to achieve higher flow velocity from the outlet 120 of the nozzle 109, not to change the phase of the powder particles. In embodiments, the main heater 105 can have a heating chamber at a predetermined temperature. In embodiments, the temperature of the main heater 105 can be up to about 900° F. In some embodiments, the temperature of the main heater 105 is about 870° F.

In embodiments, the powder feeder 107 is configured to deliver a supply of powder particles to the inlet 112 of the nozzle 109 via the second stream of pressurized carrier gas 117 such that the powder particles are entrained within the first stream of pressurized carrier gas 115 in the nozzle 109. In embodiments, the powder feeder 107 can include any suitable device for delivering a metered amount of powder particles to the nozzle 109.

For example, in embodiments, the powder feeder 107 can include a powder meter wheel which includes a plurality of perforations that act as exit openings for the powder particles. The powder meter wheel is rotatably driven by a power source to deliver powder particles to the nozzle 109 at a given feed rate. The feed rate of the powder particles can be varied by changing the rotational speed of the powder meter wheel.

The powder feeder 107 can also include a storage area for powder particles before being dispensed by the powder meter wheel. A mechanical stirrer can be provided to stir the powder particles held in the storage area. In embodiments, the mechanical stirrer can be operated with a rotational speed such that the stir rate in revolutions per minute is at least eight times greater than the rotational speed of the powder meter wheel in revolutions per minute, and is at least ten times greater in yet other embodiments.

In embodiments, the nozzle 109 can have any suitable configuration to discharge powder particles therefrom in a jet with supersonic velocity. In embodiments, the nozzle 109 can be in the form of a converging-diverging nozzle or a converging nozzle, for example. In embodiments, the powder particles, initially carried by the separate second stream (or powder stream) of pressurized carrier gas 117, can be injected into the first stream (or main gas stream) of pressurized carrier gas 115 within the nozzle 109 either at the nozzle inlet 112 or at a lower pressure point downstream of the inlet 114. In embodiments, the nozzle 109 is configured such that the main gas stream 115 and the powder stream 117 are both introduced into an inlet chamber of the nozzle 109.

In embodiments, the first stream of pressurized carrier gas 115 and the second stream of pressurized carrier gas 117 are each pressurized to at least 1.5 MPa before entering the nozzle 109. In embodiments, the second stream of pressurized carrier gas 117 is at a pressure when it enters the nozzle 109 that is higher than the pressure of the first stream of pressurized carrier gas 115 when it enters the nozzle 109. For example, in embodiments, the first stream of pressurized carrier gas 115 is pressurized to about 300 psi and the second stream of pressurized carrier gas 117 is pressurized to about 330 psi when they respectively enter the nozzle 109.

The nozzle 109 can be configured to accelerate the velocity, and decrease the pressure of, the carrier gas of the first and second streams 115, 117 travelling through the nozzle 109 such that the deformable powder particles conveyed in the gas carrier are also accelerated to a high velocity. The high velocity gas stream is generated through the expansion of the pressurized, preheated, carrier gas within the nozzle 109. In embodiments, the carrier gas accelerates to supersonic velocity (e.g., in a range between Mach 1 and Mach 4) as it expands in the nozzle 109. The carrier gas decreases in pressure and cools as it expands in the nozzle 109. The powder to be deposited, which is introduced by the separate powder stream 117 either at the nozzle inlet 112 or at a lower pressure location within the nozzle 109, mixes with the main gas stream 115 and is accelerated thereby.

A jet of solid-phase particles 125 can be discharged from the outlet 120 of the nozzle 109. In embodiments, the jet of solid-phase particles 125 can be accelerated to a sufficient velocity at the outlet 120 of the nozzle 109 to promote adhesion between the particles and the target surface of the piston (e.g., a velocity in a range between about 300 m/s and 1200 m/s). The temperature of the jet of solid-phase particles 125 is less than the temperature of the first stream of pressurized carrier gas 115 entering the inlet 112 of the nozzle 109. The temperature of the jet of solid-phase particles 125 is below the melting threshold of powder material. In some embodiments, the temperature of the jet of solid-phase particles 125 exiting the nozzle 109 can be below ambient temperature.

The jet of solid-phase particles 125 is directed toward a target surface on the piston 10. When the particles strike the target surface, converted kinetic energy causes plastic deformation of the particles, which in turn causes the particle to form a bond with the target surface of the piston 10. The solid particles that impact the substrate above a threshold (critical) velocity for the powder and substrate combination will deform and bond in a layer. Thus, the cold spray system 100 can bond powder materials to a surface of the piston.

In embodiments, the cold spray system can include a turntable 128 configured to rotate the piston about its longitudinal axis LA relative to the outlet 120 of the nozzle 109 to facilitate the uniform deposition of the layer of powder particles upon the exterior surface of the piston 10. In embodiments, the nozzle 109 can be configured to be movable relative to the piston 10 along the longitudinal axis LA, such as, by providing a robotic arm configured to selectively move the nozzle along the longitudinal axis LA relative to the piston 10, for example. In other embodiments, the nozzle 109 can be configured to be movable relative to the piston 10 along or about another axis and/or with an additional number of degrees of freedom.

In embodiments of a method of remanufacturing a piston following principles of the present disclosure, the piston is remanufactured using cold spray depositing techniques. In embodiments, a method of remanufacturing a piston following principles of the present disclosure can be used to make any embodiment of a piston according to principles discussed herein.

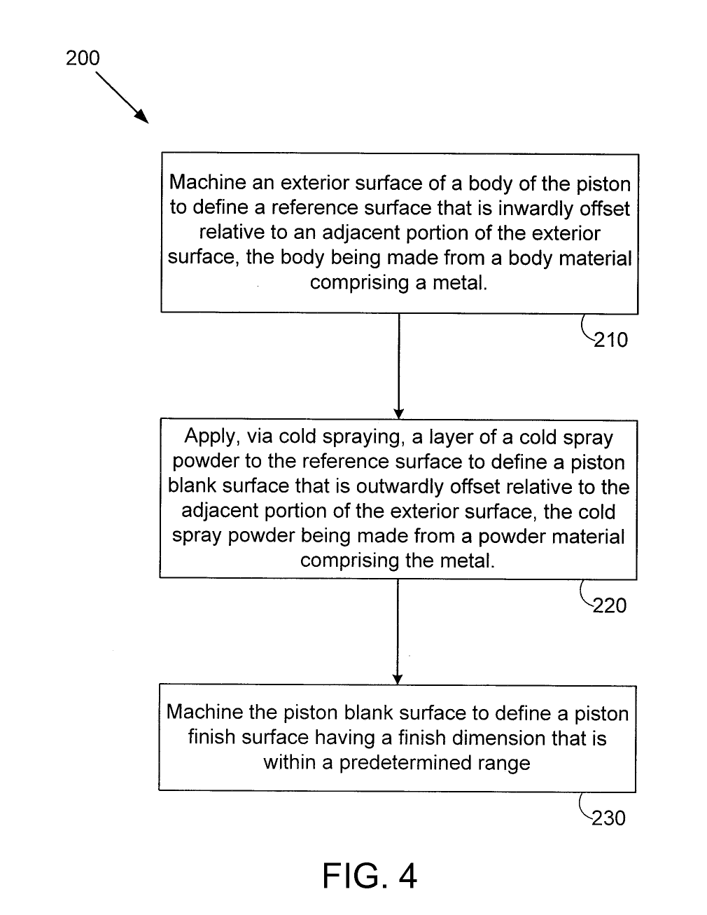

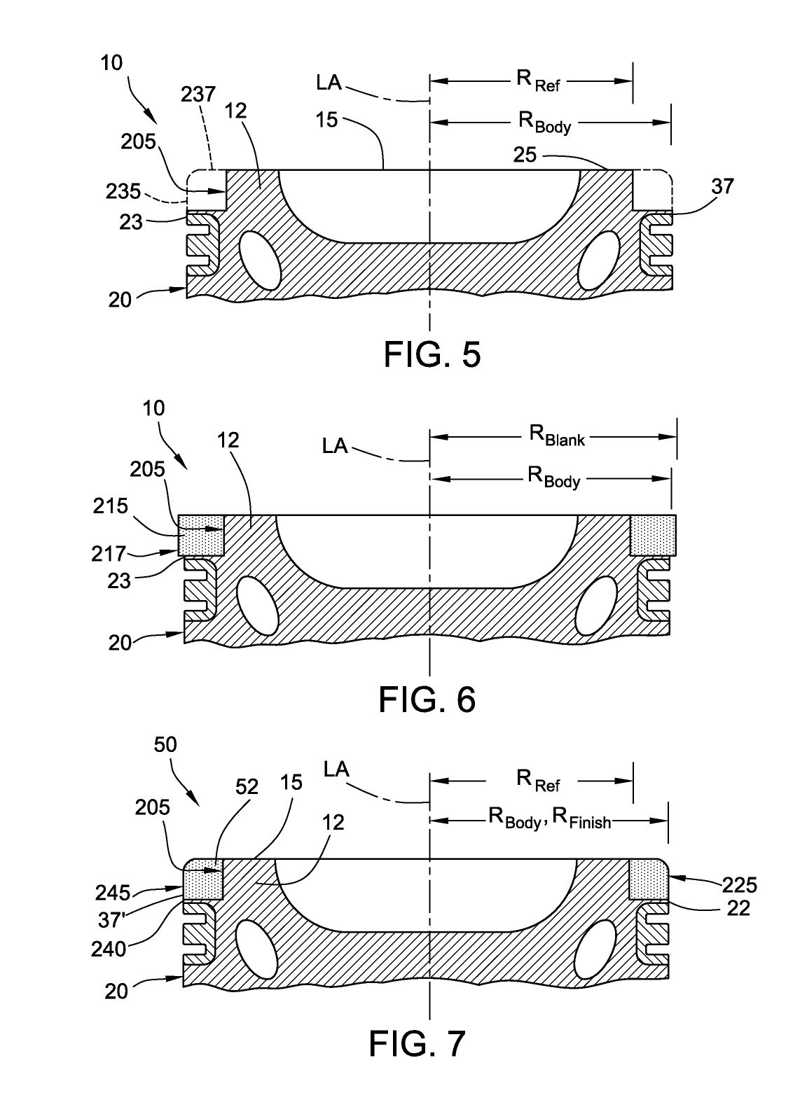

Referring to FIG. 4, steps of an embodiment of a method 200 of remanufacturing a piston following principles of the present disclosure are shown. The exterior surface 20 of the body 12 of the piston 10 is machined to define a reference surface 205 (step 210; see FIG. 5 also). A layer of a cold spray powder 215 is applied to the reference surface 212 via cold spraying to define a piston blank surface 217 (step 220; see FIG. 6 also). The piston blank surface 217 is machined to define a piston finish surface 225 (step 230; see FIG. 7 also).

In embodiments of a method following principles of the present disclosure, a used piston is inspected to verify that it is in a condition that would permit the remanufacturing process to be applied to it to produce a satisfactory result. For example, in embodiments, inspecting the used piston includes determining whether the piston suffers from mechanical defects or other damage that would still disqualify it from service even after undergoing the remanufacturing method 200.

In embodiments of a method following principles of the present disclosure, the piston undergoes various surface preparation steps to ready the piston to receive the cold spray powder via cold spraying techniques. In embodiments, the piston is cleaned to remove oil, grease, dirt, paint and other foreign material. In embodiments, the piston is cleaned no more than a predetermined amount of time before being coated with the cold spray powder (e.g., no more than five hours prior to coating).

In embodiments, surfaces of the piston designated for cold spray coating are cleaned by abrasive blasting with an abrasive media (e.g., aluminum oxide). In embodiments, the blast media is substantially free of contaminants that would negatively affect the body material. In embodiments, the method includes shot or grit blasting the surface of the piston prior to cold spray coating to create a rough surface.

In embodiments of a method following principles of the present disclosure, the piston is subjected to a preheating step before cold spray coating. In embodiments, each surface of the piston coming into contact with the cold spray powder can be preheated by a suitable and controllable source. In embodiments, preheating is performed to remove moisture, reduce the thermal shock effect encountered during cold spray deposition, and promote deposition efficiency and bond strength as well. In embodiments, the temperature of the piston, both during preheating and coating application, is controlled to prevent discoloration, oxidation, distortion and other conditions detrimental to the layer of the cold spray powder or the piston body.

Referring to FIGS. 4 and 5, in the machining step 210, the piston 10 can be machined to remove a worn portion 235 of the piston body 12 that would interfere with cold spraying, such as the corroded areas 40 and the defects 41 present in the crown portion 23 of the piston 10. As mentioned above, in embodiments, machining the piston 10 to define the reference surface 205 can include cleaning and otherwise removing corrosion, impurity buildups, and contamination on the exterior surface 20 of the piston 10.

In embodiments, the reference surface 205 is formed in the area of the crown land 37. In embodiments, the worn portion 235 includes at least some of the annular rim 25 of the crown end 15 such that machining the exterior surface 20 of the body 12 includes removing at least a part 237 of the annular rim 25.

As shown in FIG. 5, the reference surface 205 is inwardly offset relative to the crown portion 23 of the exterior surface 20 adjacent the reference surface 205. In the illustrated embodiment, the portion 23 of the exterior surface 20 adjacent the reference surface 205 comprises the sidewall 22. The sidewall 22 is cylindrical and has a body radius “R_{Body}.” The reference surface 205 is cylindrical and has a reference radius “R_{Ref}.” In embodiments, the reference radius R_{Ref} is smaller than the body radius R_{Body}.

In the illustrated embodiment, the reference surface 205 is cylindrical and the worn portion 235 that was removed by machining is generally annular. In other embodiments, the worn portion 235 that is removed by machining can have a different configuration and/or shape and can be placed at a different location. Accordingly, in such embodiments, the reference surface 205 can have a correspondingly different configuration, shape, and/or location, as well.

Referring to FIGS. 4 and 6, in the applying step 220, the layer of the cold spray powder 215 is applied to the reference surface 205 via cold spraying such that the piston blank surface 217 is outwardly offset relative to the crown portion 23 of the exterior surface 20 adjacent the reference surface 205. In the illustrated embodiment, the piston blank surface 217 is radially proud of the crown portion 23 of the exterior surface 20 adjacent the reference surface 205. In embodiments, any suitable cold spraying equipment can be used to apply the layer of the cold spray powder 215.

In the illustrated embodiment, the piston blank surface 217 is cylindrical and has a blank radius “R_{Blank}.” The blank radius R_{Blank} is greater than the body radius R_{Body}. In the illustrated embodiment, the layer of the cold spray powder 215 is generally annular.

In other embodiments, the worn portion 235 that is removed by machining can have a different configuration and/or shape and can be placed at a different location. Accordingly, in such embodiments, the layer of the cold spray powder 215 can have a correspondingly different configuration, shape, and/or location, as well.

In embodiments, the body 12 is made from a body material comprising a metal. The layer of the cold spray powder 215 is made from a powder material comprising the metal. In embodiments, the metal is aluminum. In embodiments, the body material and the powder material each comprises a metal alloy. In embodiments, the body material and the powder material each comprises an aluminum alloy. In embodiments, the body is made from at least one of an aluminum alloy and a steel.

In embodiments, the cold spray powder is manufactured for use in depositions using cold spraying techniques via any suitable manner. For example, the powder material can be put in powder form by known powder processing methods, such as by being processed from ingots using inert gas atomization, for example.

In embodiments of a method of remanufacturing a piston following principles of the present disclosure, applying the layer of the cold spray powder 215 to the reference surface 205 to define the piston blank surface 217 includes accelerating the cold spray powder by injecting the cold spray powder into a first stream of pressurized gas in a nozzle. The first stream of pressurized gas can be conveyed through a heater at a point upstream of the nozzle. In embodiments, the cold spray powder is conveyed into the nozzle by a second stream of pressurized gas. In embodiments, the first stream of pressurized gas and the second stream of pressurized gas are each pressurized to at least 1.5 MPa before entering the nozzle. The cold spray powder can be accelerated in the carrier gas within the nozzle and discharged from the nozzle with sufficient kinetic energy so as to form a deposited layer of the powder material that is connected to the reference surface. In embodiments, cold spray powder is accelerated so that it remains under the melting temperature of the powder material.

In embodiments, the layer of the cold spray powder 215 can be built up by applying successive coatings of the cold spray powder using multiple passes of the nozzle relative to the reference surface 205. In embodiments of a method of remanufacturing a piston following principles of the present disclosure, the layer of the cold spray powder 215 is applied to the reference surface 205 to define the piston blank surface 217 by rotating the piston 10 about the longitudinal axis LA with respect to an applicator nozzle through which the cold spray powder is dispensed.

In embodiments, the width of a single pass of the nozzle can be varied by changing the nozzle configuration. In embodiments, the position of the nozzle along the longitudinal axis LA can be varied over to increase the axial coverage of the layer of the cold spray powder 215 along the longitudinal axis LA. Multiple, slightly overlapping, parallel passes of the nozzle can be used to produce a continuous layer of the cold spray powder 215. In embodiments, the number of passes and the incremental distance between adjacent passes by the nozzle can be varied. Thus, a series of spraying passes by the nozzle can build up the layer of the cold spray powder 215 to a desired thickness. Similarly, a series of spraying passes by the nozzle can be made to cover a desired surface area of the reference surface 205 with subsequent spraying passes depositing cold spray powder adjacent to, and overlapping, coatings from previous spraying passes. In embodiments, the deposition thickness produced by the moving nozzle can be varied (e.g., from 0.01 mm to 1.0 mm) based upon the powder feed rate, the nozzle traverse speed, and the deposition efficiency. In embodiments, the cold spray nozzle is manipulated by a robot arm.

In embodiments, the control parameters of the cold spray equipment can be varied to produce a desired layer of the cold spray powder 215. Exemplary control parameters include: robot speed (linear traverse), piston rotation rate, nozzle geometry (e.g., diameter and length), main heater temperature, main heater carrier gas pressure, powder feeder carrier gas pressure, powder feed rate, and powder stir rate. In embodiments, the operational parameters of the cold spray equipment can be varied to achieve a layer of the cold spray powder 215 suitable for its intended application at a temperature that is lower than the melting temperature of the powder material.

In embodiments, the powder material can be have an improved property relative to the body material depending on the loads and service experienced by the repaired portion when the remanufactured piston 50 is put into service in its intended application. For example, in embodiments, the powder material is configured to increase the wear resistance and/or toughness relative to the body material. In embodiments, the powder material is harder than the body material.

In embodiments, the additional layers of cold spray powder comprising one powder material can be applied over a previously-deposited layer of cold spray powder comprising a different powder material. For example, in embodiments, an outer layer of cold spray powder can be made from a powder material configured to increase the wear resistance and/or toughness relative to the other powder material. Accordingly, in embodiments, different regions of the remanufactured piston 50 can have different compositions. Also, in embodiments, different laminates or layers of cold spray powder can have different compositions.

Referring to FIGS. 4, 6, and 7, the piston blank surface 217 is machined to define the piston finish surface 225 (step 230) such that the piston finish surface 225 has a dimension “R_{Finish}” which is within a predetermined range. In embodiments, the predetermined range comprises a dimensional specification for a new piston.

In the illustrated embodiment, the piston finish surface 225 comprises a rebuilt crown land 37′. In the illustrated embodiment, the piston finish surface 225 is cylindrical and has a finish radius “R_{Finish}.” The finish radius R_{Finish} is substantially the same as the body radius R_{Body} and is within a predetermined range which corresponds to the dimensional specification for the sidewall 22 of the piston 10. The finish radius R_{Finish} is greater than the reference radius R_{Ref}. The blank radius R_{Blank} is greater than the body radius R_{Body} and greater than the finish radius R_{Finish} (see FIG. 5, also).

In embodiments, the piston blank surface 217 can be machined such that the piston finish surface 225 substantially conforms to the surrounding portions of the body 12. In embodiments, the piston finish surface 225 conforms to the dimensional specifications of a new piston.

In embodiments of a method of remanufacturing a piston following principles of the present disclosure, machining the piston blank surface 217 to define the piston finish surface 225 includes detailing the piston body 12 to remove any overspray, such as at the crown end 15 or within the piston ring grooves 34, for example. The remanufactured piston 50 can be cleaned, such as by being submerged in an amine-based rust preventative solution, for example. The remanufactured piston can be gaged and inspected to verify that the remanufactured piston 50 is within the tolerance of the original specification. After meeting specification, the remanufactured piston 50 can be returned to service or forwarded to an inventory of interchangeable new pistons and remanufactured pistons.

Referring to FIG. 7, the remanufactured piston 50 includes the body 12 and the body filler portion 52. The body 12 includes the exterior surface 20 and the reference surface 205 which is inwardly offset relative to a portion 240 of the exterior surface 20 adjacent the reference surface 205. In the illustrated embodiment, the portion 240 of the exterior surface 20 adjacent the reference surface 205 comprises the sidewall 22. The reference surface 205 is disposed adjacent the crown end 15.

The body 12 is made from a body material comprising a metal. The body filler portion 52 is connected to the reference surface 205 of the body 12 and comprises a cold-spray deposited layer of a cold spray powder. The cold spray powder is made from a powder material comprising the metal. In embodiments, the metal is aluminum. The body filler portion 52 includes a machined piston finish surface 245 having a dimension R_{Finish} within a predetermined range.

In embodiments, the remanufactured piston 50 is dimensionally similar to the piston 10 prior to it being used. In embodiments, the remanufactured piston 50 meets the dimensional specifications for the piston 10 prior to it being used.

In embodiments, the body filler portion 52 can be disposed over a wear area that is oriented over a wear path associated with intended use of the remanufactured piston 50. In embodiments, the body filler portion 52 is made from a powder material which is harder than the body material of the body 12. In embodiments, the powder material can be processed so that it is in a form that is usable by the cold spraying equipment used to make the body filler portion 52 of the piston 50. In embodiments, the powder material can be provided as a supply of powder, or other suitable form, that is configured to be suitable for use with the cold spray equipment being used to construct the piston according to a method of remanufacturing a piston following principles of the present disclosure.

Embodiments of a piston constructed according to principles of the present disclosure can be made using cold spraying techniques. In embodiments, the piston 10 is remanufactured such that the remanufactured piston 50 satisfies the same set of specifications (such as tolerances and surface finishes) as that of a new piston. Moreover, it will be understood that a method of remanufacturing a piston following principles of the present disclosure can be generally applied to repair and remanufacture a variety of different types of pistons. Furthermore, although the illustrated embodiments describe a component in the form of a piston, this is only exemplary, and in general, principles of the present disclosure can be applied to any type of component. It will be apparent to one skilled in the art that various aspects of the disclosed principles relating to remanufacturing can be used with a variety of different types of wear parts. Accordingly, one skilled in the art will understand that, in other embodiments, a method of remanufacturing following principles of the present disclosure can be applied to remanufacture different types of components and can take on different forms.

### INDUSTRIAL APPLICABILITY

The industrial applicability of the embodiments of a piston and a method of remanufacturing a piston as described herein will be readily appreciated from the foregoing discussion. At least one embodiment of a piston constructed according to principles of the present disclosure can be used in a machine to help operate the machine with an extended lifespan. Embodiments of a piston according to principles of the present disclosure may find potential application in any suitable machine.

Embodiments of a piston constructed according to principles of the present disclosure can have a body filler portion configured to restore the useful life of the remanufactured piston and conform to a dimensional specification established for a new piston. The body filler portion can be made used cold spray depositing techniques. The cold spray deposition will yield a new life for the piston. The remanufactured piston can have similar properties to the new piston.

Embodiments of a method of remanufacturing a piston discharge cold spray powder at high velocity from a nozzle to impact a reference surface of the piston such that the cold spray powder bonds with the reference surface (and in embodiments previously-deposited material) resulting in a uniform deposition of cold spray powder with very little porosity and high bond strength. Moreover, deleterious effects of deposit oxidation, evaporation, and residual stresses can be avoided. Embodiments of a method of remanufacturing a piston can be used to restore dimensionally discrepant pistons, or pistons requiring rebuilding from corrosion and wear (e.g. abrasion, cavitations, and erosion) but not limited to these applications. Good corrosion protection can be achieved by dense, impermeable cold sprayed deposits.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A method of remanufacturing a piston, the method of remanufacturing comprising:
machining an exterior surface of a body of the piston to define a reference surface, the reference surface being inwardly offset relative to a portion of the exterior surface adjacent the reference surface, the body being made from a body material comprising a metal;
applying, via cold spraying, a layer of a cold spray powder to the reference surface to define a piston blank surface, the piston blank surface being outwardly offset relative to the portion of the exterior surface adjacent the reference surface, the cold spray powder being made from a powder material comprising the metal;
machining the piston blank surface to define a piston finish surface, the piston finish surface having a dimension, the dimension being within a predetermined range.

2. The method of remanufacturing according to claim 1, wherein the metal is aluminum.

3. The method of remanufacturing according to claim 1, wherein the body material and the powder material each comprises a metal alloy.

4. The method of remanufacturing according to claim 3, wherein the body material and the powder material each comprises an aluminum alloy.

5. The method of remanufacturing according to claim 1, wherein applying the layer of the cold spray powder to the reference surface to define the piston blank surface includes accelerating the cold spray powder by injecting the cold spray powder into a first stream of pressurized gas in a nozzle, the first stream of pressurized gas being conveyed through a heater at a point upstream of the nozzle.

6. The method of remanufacturing according to claim 5, wherein the cold spray powder is conveyed into the nozzle by a second stream of pressurized gas.

7. The method of remanufacturing according to claim 6, wherein the first stream of pressurized gas and the second stream of pressurized gas are each pressurized to at least 1.5 MPa before entering the nozzle.

8. The method of remanufacturing according to claim 1, wherein the portion of the exterior surface adjacent the reference surface comprises a sidewall portion, the sidewall portion being cylindrical and having a body radius, and wherein the reference surface is cylindrical and has a reference radius, the reference radius being smaller than the body radius.

9. The method of remanufacturing according to claim 8, wherein the body of the piston defines a longitudinal axis, the sidewall portion circumscribing, and extending along, the longitudinal axis, and wherein the layer of the cold spray powder is applied to the reference surface to define the piston blank surface by rotating the piston about the longitudinal axis with respect to a nozzle through which the cold spray powder is dispensed.

10. The method of remanufacturing according to claim 8, wherein the piston blank surface is cylindrical and has a blank radius, the blank radius being greater than the body radius.

11. The method of remanufacturing according to claim 8, wherein the piston finish surface is cylindrical and has a finish radius, the finish radius being greater than the reference radius.

12. The method of remanufacturing according to claim 11, wherein the finish radius is substantially the same as the body radius.

13. The method of remanufacturing according to claim 11, wherein the piston blank surface is cylindrical and has a blank radius, the blank radius being greater than the body radius and greater than the finish radius.

14. The method of remanufacturing according to claim 8, wherein the body includes a crown end, the crown end including an annular rim and a recessed portion, the annular rim circumscribing the recessed portion and cooperating with the recessed portion to define a combustion bowl, the reference surface disposed adjacent the crown end.

15. The method of remanufacturing according to claim 14, wherein machining the exterior surface of the body includes removing a part of the annular rim.

16. A piston comprising:
a body, the body including an exterior surface and a reference surface, the reference surface being inwardly offset relative to a portion of the exterior surface adjacent the reference surface, the body being made from a body material comprising a metal;
a body filler portion, the body filler portion connected to the reference surface of the body, the body filler portion comprising a cold-spray deposited layer of a cold spray powder, the cold spray powder being made from a powder material comprising the metal, and wherein the body filler portion includes a machined piston finish surface, the machined piston finish surface having a dimension, the dimension being within a predetermined range.

17. The piston according to claim 16, wherein the metal is aluminum.

18. The piston according to claim 16, wherein the portion of the exterior surface adjacent the reference surface comprises a sidewall portion, the sidewall portion being cylindrical and having a body radius, and wherein the reference surface is cylindrical and has a reference radius, the reference radius being smaller than the body radius.

19. The piston according to claim 18, wherein the machined piston finish surface is cylindrical and has a finish radius, the finish radius being greater than the reference radius and substantially the same as the body radius.

20. The piston according to claim 18, wherein the body includes a crown end, the crown end including an annular rim and a recessed portion, the annular rim circumscribing the recessed portion and cooperating with the recessed portion to define a combustion bowl, the reference surface disposed adjacent the crown end.
